(19) United States
(12) Patent Application Publication
(10) Pub. No.: US 2009/0199247 A1
(43) Pub. Date: Aug. 6, 2009

(54) VIDEO CONTENT DISTRIBUTION SYSTEM AND VIDEO CONTENT DISTRIBUTION RESERVATION METHOD

(75) Inventor: Yuki KANBE, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/361,854

(22) Filed: Jan. 29, 2009

(30) Foreign Application Priority Data
Jan. 31, 2008 (JP) 2008-022004

(51) Int. Cl. H04N 7/173

(52) U.S. Cl. 725/87

(57) ABSTRACT

According to one embodiment, a content distribution reservation method includes causing a server to distribute program distribution data including video content and preview content of other video content to a terminal device as the program distribution data, causing the terminal device to reproduce the program distribution data the program distribution data, causing the terminal device detect whether a viewing reservation event is generated or not, causing the terminal device to transmit a reservation command of the other video content to the server, causing the server to register the other video content in viewing reservation information, causing the terminal device to request distribution list data for displaying a list of video contents, causing the server to generate distribution list data, and transmits the distribution list data to the terminal device, and causing the terminal device to display a distribution list on a display device based on the distribution list data.

### CROSS-REFERENCE TO RELATED APPLICATIONS

This application is based upon and claims the benefit of priority from Japanese Patent Application No. 2008-022004, filed Jan. 31, 2008, the entire contents of which are incorporated herein by reference.

### BACKGROUND

1. Field

One embodiment of the present invention relates to a video content distribution system that distributes video content from a server to a user terminal device and a video content distribution reservation method.

2. Description of the Related Art

At present, there is carried out a video-on-demand (VOD) service in which video content specified by the user is distributed from a server by means of the Internet.

Also, movie content is often distributed by VOD, and a preview of a movie is run on the basis of an intention of a content provider. In this case, at that time point, date and time of a VOD service distribution may not be determined.

PCT International Application Laid-Open No. 2006-500811 (FIG. 5) discloses a technique that allows extraction of only a preview clip from a video signal and recording the preview clip, viewing a collection of preview clips, and reservation of recording a main part from the preview. Then, as a method of recording a main part from a preview, there is a method of embedding data indicating broadcasting time and a channel of the main part in a preview video.

In the technique described above, reservation cannot be made with respect to content for which a service provision period is not fixed at the time of reservation or is changed before broadcasting.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of a video content distribution system according to a first embodiment;

FIG. 2 is an exemplary block diagram showing a configuration of a server and a user terminal device shown in FIG. 1;

FIG. 3 is an exemplary flowchart showing steps of distributing content data and registering reservation information by the video content distribution system;

FIG. 4 is an exemplary view showing an example of a display list displayed on an LCD by a distribution list displaying module shown in FIG. 2;

FIG. 5 is an exemplary view showing an example of a video displayed on an LCD by a program distribution data reproducing module shown in FIG. 2;

FIG. 6 is an exemplary flowchart showing steps in which the user terminal device carries out recording of content on the basis of recording reservation information;

FIG. 7 is an exemplary block diagram showing a configuration of the server and the user terminal device according to a second embodiment;

FIG. 8 is an exemplary flowchart showing steps of distributing content data and registering reservation information by the video content distribution system; and

FIG. 9 is an exemplary flowchart showing steps in which the user terminal device carries out recording of content on the basis of the recording reservation information.

### DETAILED DESCRIPTION

Various embodiments according to the invention will be described hereinafter with reference to the accompanying drawings. In general, according to one embodiment of the invention, a video content distribution system that carries out communication between a user terminal device and a server and distributes program distribution data including video content specified by the user from the server to the user terminal device, wherein the server comprises: a distribution module configured to distribute program distribution data including video content and preview content of other video content to the user terminal device as the program distribution data, in case a distribution request for distributable video content is received from the user terminal device; a registration module configured to register the other video content in viewing reservation information, in case a viewing reservation command for the other video content is received from the user terminal device; and a distribution list data generation and transmission module configured to generate distribution list data for displaying a distribution list including information about video content that can be distributed currently, information about video content stored in the viewing reservation information, and distribution information about the video content, and transmit the distribution list data to the user terminal device in case a distribution list data request is received from the user terminal device, and the user terminal device comprises: a request module configured to request distribution list data for displaying a list of video contents to the server; a display module configured to display a distribution list on a display device based on the distribution list data received on the basis of the request; a distribution event detection module configured to detect a distribution event for viewing a viewable video content in the distribution list; a distribution request transmission module configured to transmit a distribution request for video content for which the distribution event is detected to the server, in case the distribution event is detected; a reproduction module configured to reproduce program distribution data distributed from the server on the basis of the distribution request; a viewing reservation event detection module configured to detect a viewing reservation event while the preview content included in the program distribution data distributed from the server is reproduced; and a viewing reservation command transmission module configured to transmit the viewing reservation command of the other video content to the server, in case the viewing reservation event is detected.

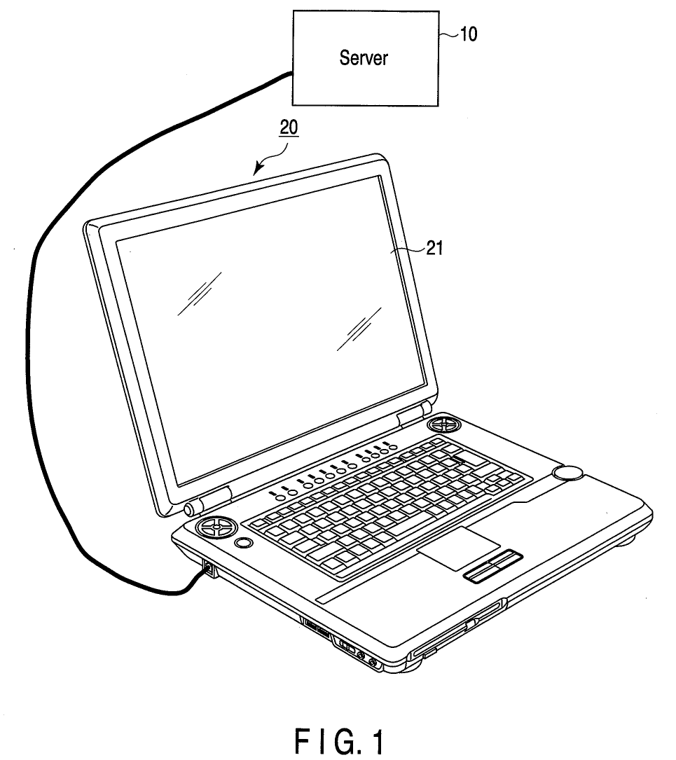

FIG. 1 is a block diagram showing a configuration of a video content distribution system according to the first embodiment of the present invention.

As shown in FIG. 1, the video content distribution system includes a server 10 that distributes video content, and a user terminal device 20 that receives video content distributed from the server 10 and displays the video content on a display device. As shown in FIG. 1, a notebook-type personal computer is used as the user terminal device 20. The notebook-type personal computer includes an LCD 21 as a display device.

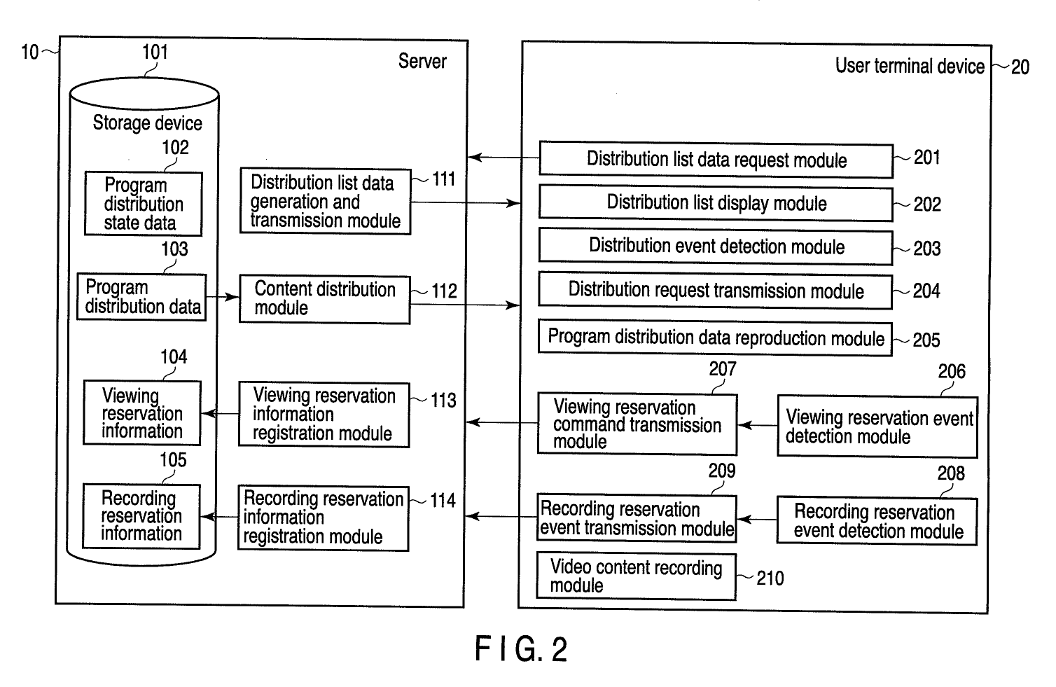

FIG. 2 is a block diagram showing configurations of the server 10 and the user terminal device 20 shown in FIG. 1.

The server 10 includes a storage device 101, a content distribution module 112, a viewing reservation information registration module 113, a recording reservation information registration module 114, a distribution list data generation and transmission module 111, and the like.

The storage device 101 stores program distribution state data 102, program distribution data 103, viewing reservation information 104, recording reservation information 105, and the like. The program distribution state data 102 includes information with respect to a distribution period (including an undecided case) of contents that are being distributed and that are to be distributed. In the viewing reservation information 104, information about content that the user has reserved for viewing is registered. In the recording reservation information 105, information about content that the user has reserved for recording is registered. The viewing reservation information 104 and the recording reservation information 105 include, for example, a content ID that is allocated uniquely to each item of content, and the like. Further, the viewing reservation information 104 and the recording reservation information 105 include information, such as a title, from which content can be specified, so that content for which the distribution list data generation and transmission module has not created a list can be reserved. By having information, such as a content ID or a title, as described above, viewing reservation and recording reservation can be carried out even when data and time of distribution have not been decided yet.

The content distribution module 112 distributes the program distribution data 103 including video content specified by the user terminal device 20 to the user terminal device 20. The program distribution data 103 includes preview content of video content to be distributed, together with data of the video content specified by the user terminal device 20.

In case the viewing reservation information registration module 113 receives a viewing reservation command of preview content from the user terminal device 20, the viewing reservation information registration module 113 registers the other video content in the viewing reservation information 104.

In case the recording reservation information registration module 114 receives a viewing reservation command of preview content from the user terminal device 20, the recording reservation information registration module 114 registers the other video content in the viewing reservation information 104.

In case the distribution list data generation and transmission module 111 receives a distribution list data request from the user terminal device 20, the distribution list data generation and transmission module 111 generates distribution list data for displaying a distribution list that includes information about video content currently distributable, information about video content stored in the viewing reservation information 104 and the recording reservation information 105 and distribution information thereof.

The user terminal device 20 includes a distribution list data request module 201, a distribution list display module 202, a distribution event detection module 203, a distribution request transmission module 204, a program distribution data reproduction module 205, a viewing reservation event detection module 206, a viewing reservation command transmission module 207, a recording reservation event detection module 208, a recording reservation command transmission module 209, a video content recording module 210, and the like.

The distribution list data request module 201 requests the server 10 to transmit distribution list data for displaying a list of video contents.

The distribution list display module 202 generates a signal for displaying a distribution list based on the distribution list data transmitted from the server 10 on the display device.

The distribution event detection module 203 detects a distribution event for viewing a viewable video content in the distribution list.

In case the distribution event is detected, the distribution request transmission module 204 transmits a distribution request of video content of the detected distribution event to the server 10.

The program distribution data reproduction module 205 reproduces the program distribution data 103 distributed from the server 10 on the basis of the distribution request.

The viewing reservation event detection module 206 detects a viewing reservation event while preview content included in the program distribution data 103 distributed from the server 10 is reproduced.

In case the viewing reservation event detection module 206 detects the viewing reservation event, the viewing reservation command transmission module 207 transmits a viewing reservation command of video content corresponding to the preview content to the server 10.

The recording reservation event detection module 208 detects a recording reservation event while the preview content included in the program distribution data 103 distributed from the server 10 is reproduced.

In case the recording reservation event detection module 208 detects the recording reservation event, the recording reservation command transmission module 209 transmits a recording reservation command of video content corresponding to the preview content to the server 10.

The video content recording module 210 automatically records the content reserved for recording.

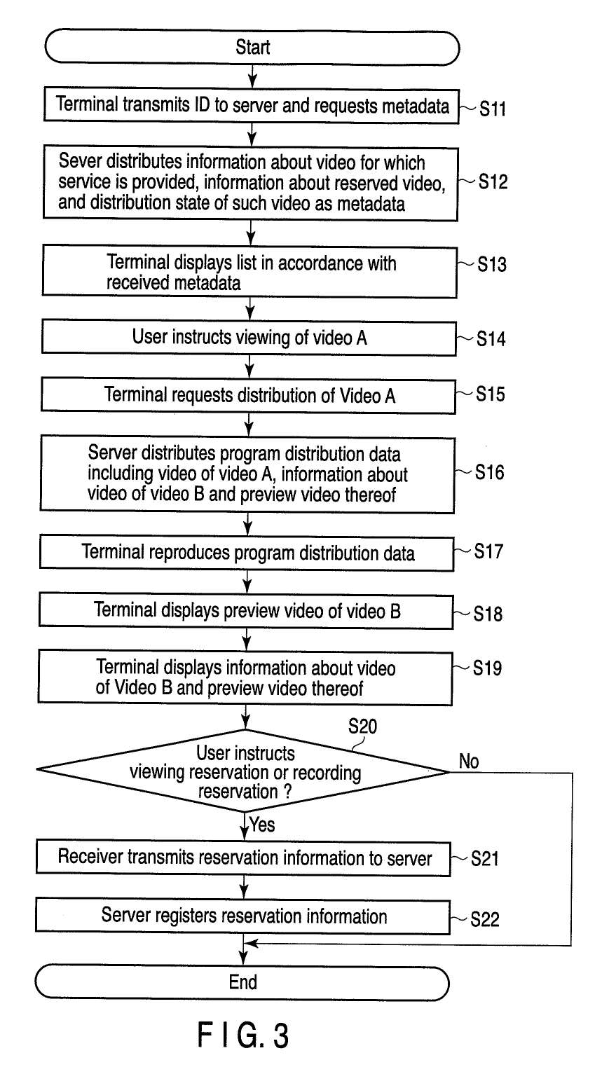

Next, with reference to a flowchart in FIG. 3, description will be made with respect to steps of processing of the present system.

The distribution list data request module 201 of the user terminal device 20 transmits a transmission request of metadata together with an identification (ID) (for example, one that is provided for each terminal and user) provided from an operating company of the server 10 (block S11). The metadata is data for displaying a list of information about a video for which a service is being provided, information about a video reserved by the user terminal device 20, and a distribution state of such videos, on the LCD 21 of the user terminal device 20.

The distribution list data generation and transmission module 111 of the server 10 searches for information about a video for which a service is currently provided with reference to the program distribution state data 102, in accordance with a request from the user terminal device 20. In addition, the distribution list data generation and transmission module 111 searches for a distribution state (distribution period) of a registered content with reference to the viewing reservation information 104, the recording reservation information 105 and the program distribution state data 102. The distribution list data generation and transmission module 111 generates distribution list data for displaying information about a video currently served, information about a video of content registered in the viewing reservation information 104 and the recording reservation information 105, and a distribution state of these videos in a list, and transmits the generated distribution list data to the user terminal device 20 (block S12). The distribution list data is a BML document.

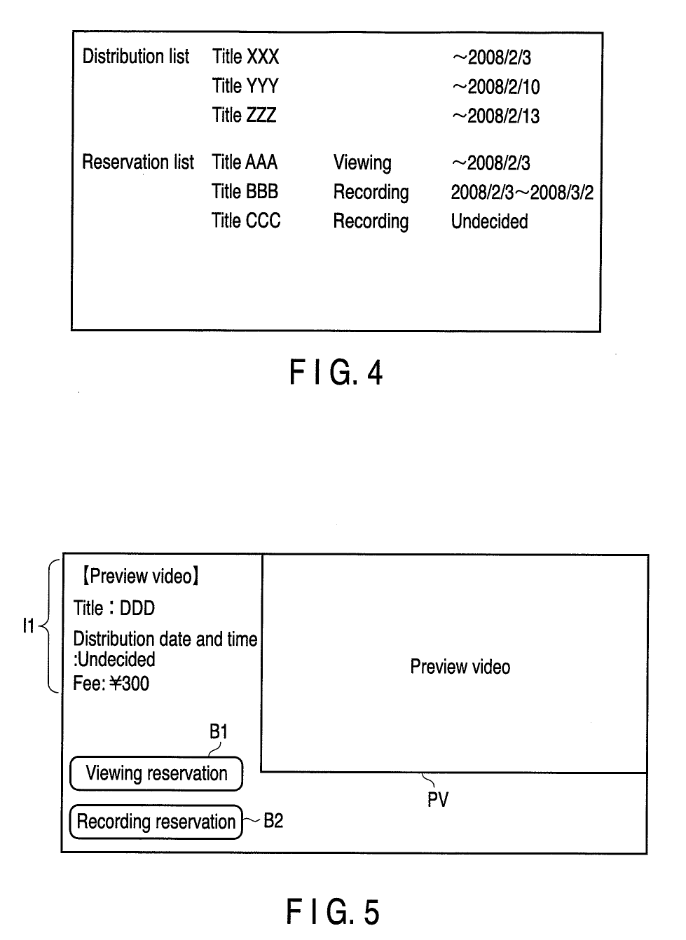

When the distribution list data is received, the distribution list display module 202 of the user terminal device 20 displays a distribution list on the LCD 21 (block S13). FIG. 4 shows an example of the distribution list. As shown in FIG. 4, a title of a distribution list currently distributed and a distribution period thereof are displayed. In addition, a reservation type (viewing or recording) and a distribution state (a distribution period if a distribution period is determined, or “undecided” when a distribution period is not decided), together with titles (Title AAA to Title CCC), of contents for which the user has carried out viewing reservation or recording reservation are displayed in a reservation list.

When the user instructs viewing of distributable content in the list, a distribution event is generated (block S14). When the distribution event detection module 203 detects the distribution event, the distribution event detection module 203 transmits a distribution request of the instructed content (Video A) to the server 10 together with an ID (block S15). At this time, if content included in the reservation list is distributed, it is displayed that the content is being distributed in the reservation list, and the user can instruct viewing of the content in the reservation list. Therefore, if the user pays attention to the reservation list, the user can view content that the user reserved for viewing in the past. In order to distinguish content being distributed and content not yet distributed in the reservation list, colors of titles and the like of content are preferably varied.

The content distribution module 112 of the server 10 distributes the program distribution data 103 including the instructed content (Video A) to the user terminal device 20 in accordance with the distribution request (block S16). In the program distribution data 103, data of a preview video of Video B is stored together with data of video of the instructed content (Video A). The preview video of Video B is normally reproduced before the video of the instructed content (Video A).

The program distribution data reproduction module 205 of the user terminal device 20 reproduces the program distribution data 103 being received (block S17). When operation for displaying data broadcasting is carried out while the preview video of Video B is reproduced (block S18), information I1 of Video B, a viewing reservation button B1, and a recording reservation button B2 are displayed around a preview video PV of Video B as shown in FIG. 5 (block S19). When the user selects the viewing reservation button B1, a viewing reservation event is generated. In addition, when the user selects the recording reservation button B2, a recording reservation event is generated.

In case the viewing reservation event detection module 206 detects that the viewing reservation event is generated (YES in block S20), or in case the recording reservation event detection module 208 detects that the recording reservation event is generated, the viewing reservation command transmission module 207, or the recording reservation command transmission module 209 transmits the viewing reservation information 104 or the recording reservation information 105 to the server 10 (block S21).

The server 10 registers reservation information (block S22). That is, in case the viewing reservation information 104 is received, the viewing reservation information registration module 113 of the server 10 registers the reservation information in the viewing reservation information 104. In case the recording reservation information 105 is received, the recording reservation information registration module 114 of the server 10 registers the reservation information in the recording reservation information 105.

In the above processing, the user can carry out viewing reservation or recording reservation. Also, the user can discriminate states of reserved contents by viewing the list. Then, when a reserved content is distributed, the user can select and view the content.

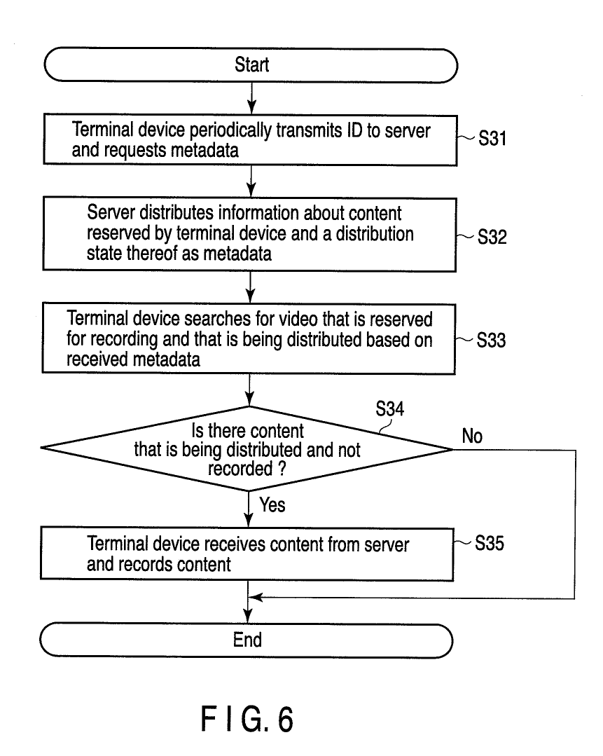

Next, steps of processing in which the user terminal device 20 automatically records content reserved for recording will be described with reference to a flowchart shown in FIG. 6.

The video content recording module 210 of the user terminal device 20 periodically (for example, on a daily basis) transmits an ID, and requests the server 10 to transmit distribution list data (metadata) (block S31). As described above, the distribution list data generation and transmission module 111 of the server 10 creates distribution list data, and transmits the distribution list data to the user terminal device 20 (block S32).

The video content recording module 210 of the user terminal device 20 searches for a video that is reserved for recording and that is being distributed in the received distribution list data if such a video exists (block S33). In case there is content that is being distributed but not recorded (YES in block S34), the video content recording module 210 transmits a distribution request for the searched video to the server 10. Then, the video content recording module 210 records the video that is distributed in accordance with the distribution request (block S35).

In the above processing, a program that is reserved for recording is automatically recorded.

### Second Embodiment

In the above embodiment, the viewing reservation information 104 and the recording reservation information 105 are held on the server 10 side. In the present embodiment, description will be made with respect to an example where the user terminal device 20 side holds the viewing reservation information 104 and the recording reservation information 105.

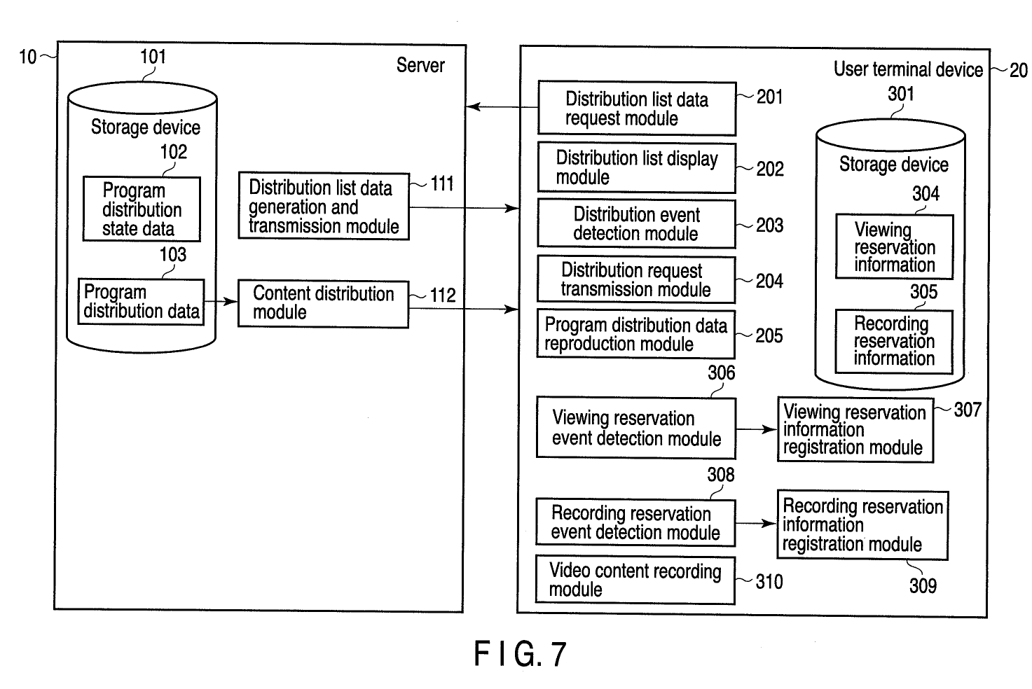

FIG. 7 is a block diagram showing a configuration of a video content distribution system according to the second embodiment of the present invention. In FIG. 7, a module unit that is similar to the module unit described in the first embodiment is attached with the same reference number.

The server 10 includes the storage device 101, the content distribution module 112, the distribution list data generation and transmission module 111, and the like. The storage device stores the program distribution state data 102 and the program distribution data 103.

The user terminal device 20 includes a storage device 301, the distribution list data request module 201, the distribution list display module 202, the distribution event detection module 203, the distribution request transmission module 204, the program distribution data reproduction module 205, the video content recording module 210, the viewing reservation event detection module 206, a viewing reservation information registration module 307, the recording reservation event detection module 208, a recording reservation information registration module 309, a video content recording module 310, and the like. The storage device 301 stores viewing reservation information 304 and recording reservation information 305.

In case a viewing reservation event detection module 306 detects a viewing reservation event, the viewing reservation information registration module 307 registers the reservation information in the viewing reservation information 304. Also, in case the viewing reservation event detection module 306 detects a recording reservation event, the recording reservation information registration module 309 registers the reservation information in the recording reservation information 305.

The video content recording module 310 automatically records content registered in the recording reservation information 305.

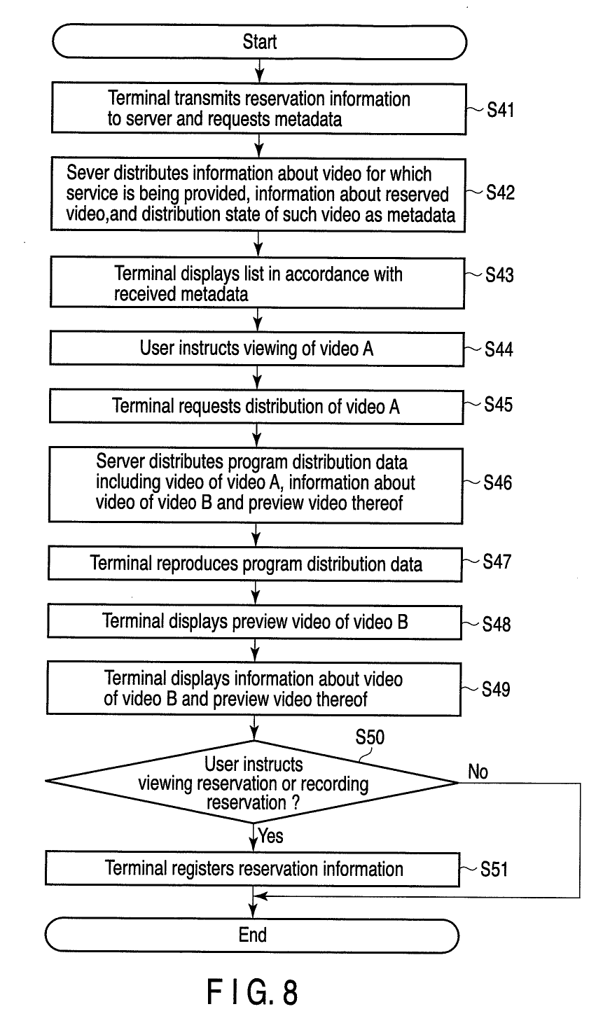

Next, with reference to FIG. 8, description will be made with respect to steps of registering reservation information in the viewing reservation information 304 or the recording reservation information 305, and viewing content registered in the viewing reservation information 304.

The distribution list data request module 201 of the user terminal device 20 transmits a transmission request of metadata together with an ID provided from an operating company of the server 10 and reservation information (the viewing reservation information 304 and the recording reservation information 305) (block S41). The metadata is data for displaying a list of information about a video for which a service is being provided, information about a video reserved by the user terminal device 20, and a distribution state of such videos, on the LCD 21 of the user terminal device 20.

The distribution list data generation and transmission module 111 of the server 10 searches for information about a video for which a service is currently provided with reference to the program distribution state data 102, in accordance with a request from the user terminal device 20. In addition, the distribution list data generation and transmission module 111 searches for a distribution state (distribution period) of a registered content with reference to the viewing reservation information 304, the recording reservation information 305, and the program distribution state data 102 being received. The distribution list data generation and transmission module 111 generates distribution list data for displaying information about a video currently served, information about a video of content registered in the viewing reservation information 304 and the recording reservation information 305, and a distribution state of these videos in a list, and transmits the generated distribution list data to the user terminal device 20 (block S42). The distribution list data is a BML document.

When the distribution list data is received, the distribution list display module 202 of the user terminal device 20 displays a distribution list on the LCD 21 (block S43).

When the user instructs viewing of distributable content in the list, a distribution event is generated (block S44). When the distribution event detection module 203 detects the distribution event, the distribution event detection module 203 transmits a distribution request of the instructed content (Video A) to the server 10 together with an ID (block S45). At this time, if content included in the reservation list is distributed, it is displayed that the content is being distributed in the reservation list, and the user can instruct viewing of the content in the reservation list. Therefore, if the user pays attention to the reservation list, the user can view content that the user reserved for viewing in the past.

The content distribution module 112 of the server 10 distributes the program distribution data 103 including the instructed content (Video A) to the user terminal device 20 in accordance with the distribution request (block S46). In the program distribution data 103, data of a preview video of Video B is stored together with data of video of the instructed content (Video A). The preview video of Video B is normally reproduced before the video of the instructed content (Video A).

The program distribution data reproduction module 205 of the user terminal device 20 reproduces the program distribution data 103 being received (block S47). When operation for displaying data broadcasting is carried out while the preview video of Video B is reproduced (block S48), information I1 of Video B, a viewing reservation button B1, and a recording reservation button B2 are displayed around a preview video PV of Video B as shown in FIG. 5 (block S49). When the user selects the viewing reservation button B1, a viewing reservation event is generated. In addition, when the user selects the recording reservation button B2, a recording reservation event is generated.

In case the viewing reservation event detection module 306 detects that the viewing reservation event is generated (YES in block S50), or in case the recording reservation event detection module 308 detects that the recording reservation event is generated, the viewing reservation information registration module 307 registers the reservation information in the viewing reservation information 304 or the recording reservation information registration module 309 registers the reservation information in the recording reservation information 305 (block S51).

In the above processing, the user can carry out viewing reservation or recording reservation. Also, the user can discriminate states of reserved contents by viewing the list. Then, when a reserved content is distributed, the user can select and view the content.

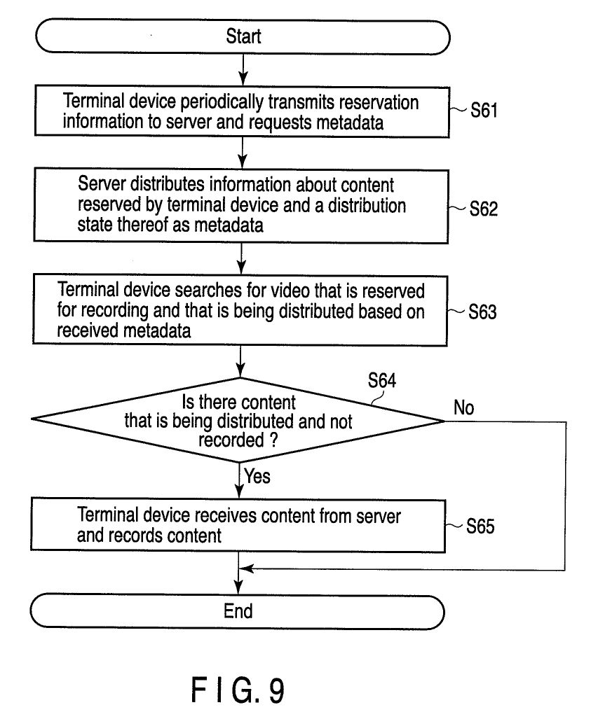

Next, steps of processing in which the user terminal device 20 automatically records content reserved for recording will be described with reference to a flowchart shown in FIG. 9.

The video content recording module 310 of the user terminal device 20 periodically (for example, on a daily basis) transmits an ID and the recording reservation information 305, and requests the server 10 to transmit distribution list data (metadata) (block S61). As described above, the distribution list data generation and transmission module 111 of the server 10 creates distribution list data, and transmits the distribution list data to the user terminal device 20 (block S62).

The video content recording module 310 of the user terminal device 20 searches for a video that is reserved for recording and that is being distributed in the received distributed list data if such a video exists (block S63). In case there is content that is being distributed and not recorded (YES in block S64), the video content recording module 310 transmits a distribution request for the searched video to the server 10. Then, the video content recording module 210 records the video that is distributed in accordance with the distribution request (block S65).

By the above processing, a program that is reserved for recording is automatically recorded on the basis of the recording reservation information 305 retained in the user terminal device 20.

In the above embodiments, description was made with respect to an example where the user terminal device 20 is a notebook-type personal computer. However, the user terminal device 20 may be a TV and mobile equipment having a function of a video-on-demand service. Also, the present invention is applicable for an IPTV service and a terrestrial digital broadcasting redistribution service other than the video-on-demand service.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video content distribution system configured to communicate between a terminal device and a server and to distribute program distribution data comprising a video content from the server to the terminal device, wherein
the server comprises:
a distributor configured to distribute program data comprising a first video content and a preview content of a second video content to the terminal device, when a distribution request for a distributable video content is received from the terminal device;
a registration module configured to register the second video content in viewing reservation information, when the server receives a viewing reservation command for the second video content from the terminal device; and
a distribution list data module configured to generate distribution list data for displaying a distribution list comprising information about video contents currently distributable, information about video contents stored in the viewing reservation information, and distribution information about the video contents, and configured to transmit the distribution list data to the terminal device when the server receives a distribution list data request from the terminal device, and
the terminal device comprises:
a request module configured to send a request of distribution list data for displaying a list of video contents to the server;
a display controller configured to display a distribution list on a display based on the distribution list data received in response to the request;
a distribution event detection module configured to detect a distribution event for viewing an available video content for viewing in the distribution list;
a distribution request transmitter configured to transmit a distribution request to the server for a video content for the detected distribution event, when the distribution event is detected;
a playback module configured to play back distributed program data from the server in response to the distribution request;
a viewing reservation event detection module configured to detect a viewing reservation event while the terminal device is playing back the preview content in the distributed program data; and
a viewing reservation command transmitter configured to transmit the viewing reservation command of the second video content to the server, when the terminal device detects the viewing reservation event.

2. The video content distribution system of claim 1, wherein
the server is configured to generate the distribution list data comprising a distribution period of video content if the server receives a recording reservation command from the terminal device, and to transmit the distribution list data to the terminal device, and
the terminal device further comprises:
a recording reservation event detection module configured to detect a recording reservation event while the terminal device is playing back the preview content;
a recording reservation command transmitter configured to transmit a recording reservation command of the second video content to the server, when the recording reservation event is detected; and
a recorder configured to refer to the distribution list data, to send a request to the server to distribute video content for the transmitted recording reservation command if the video content is currently available for distribution, and to record the distributed video content.

3. A video content distribution system configured to communicate between a terminal device and a server, and to distribute program data comprising a video content from the server to the terminal device, wherein
the server comprises:
a reservation list data module configured to generate content reservation list data for displaying a content reservation list comprising distribution period information about video contents stored in viewing reservation information and configured to transmit the content reservation list data to the terminal device, when the server receives the viewing reservation information from the terminal device; and
a distributor configured to distribute program data comprising a first video content and a preview content of a second video content to the terminal device, when a distribution request for a distributable video content is received from the terminal device, and
the terminal device comprises:
a display controller configured to display a reservation list from the reservation list data on a display;
a distribution event detection module configured to detect a distribution event for viewing an available video content for viewing in the reservation list;
a distribution request transmitter configured to transmit a distribution request to the server for a video content for the detected distribution event, when the distribution event is detected;
a playback module configured to play back distributed program data from the server on the basis of the distribution request;
a viewing reservation event detection module configured to detect a viewing reservation event while the terminal device is playing back the preview content in the distributed program data;
a viewing reservation information registration module configured to register the second video content to viewing reservation information, when the viewing reservation event is detected; and
a viewing reservation information transmitter configured to transmit the viewing reservation information to the terminal device.

4. The video content distribution system of claim 3, wherein
the server further comprises:
a recording reservation list data module configured to generate recording reservation list data comprising distribution period information about video contents stored in recording reservation information and configured to transmit the recording reservation list data, when the server receives the recording reservation information from the terminal device, and
the terminal device further comprises:
a recording reservation event detection module configured to detect a recording reservation event while the terminal device is playing back the preview content;
a recording reservation information registration module configured to register the second video content to recording reservation information, when the recording reservation event is detected;
a recording reservation information transmitter configured to transmit the recording reservation information to the server;
a search module configured to refer to the recording reservation list data and to search for video content distributed from the server; and
a recorder configured to transmit a distribution request of the searched video content to the server, and to record the video content distributed from the server.

5. A video content distribution reservation method for distributing program data comprising video content from a server to a terminal device according to communication between the terminal device and the server, the method comprising:
receiving a distribution request for a distributable video content at the server from the terminal device;
distributing program data comprising a video content and a preview content of a second video content from the server to the terminal device as the program data in response to the distribution request;
playing back the program data distributed from the server in response to the distribution request at the terminal device;
detecting whether a viewing reservation event is generated at the terminal device while the terminal device is playing back the preview content in the program data distributed from the server;
transmitting a viewing reservation command of the second video content from the terminal device to the server, when the viewing reservation event is detected;
receiving the viewing reservation command for the second video content at the server from the terminal device;
registering the second video content in viewing reservation information of the server, in response to the viewing reservation command for the second video content;
sending request distribution list data for displaying a list of video contents from the terminal device to the server,
generating distribution list data for displaying a distribution list comprising information about video contents currently distributable, information about video contents stored in the viewing reservation information, and distribution information about the video contents at the server;
transmitting the distribution list data from the server to the terminal device when the server receives a distribution list data request from the terminal device; and
displaying a distribution list based on the distribution list data in response to the request on a display of the terminal device.

6. The video content distribution reservation method of claim 5, further comprises:
detecting at the user terminal device whether a recording reservation event is generated while the terminal device is playing back the preview content;
transmitting a recording reservation command of the second video content from the terminal device to the server, when the terminal device detects the recording reservation event;
registering information about the second video content to recording reservation information at the server, when the server receives a recording reservation command of the second video content from the terminal device;
generating the distribution list data comprising information about a distribution period related to a video content for the transmitted recording reservation command at the server;
transmitting the distribution list data from the server to the terminal device;
referring to the distribution list data at the terminal device;
sending requests from the terminal device to the server to distribute video content for the transmitted recording reservation command when the video content is currently distributable; and
recording the distributed video content at the terminal device.

7. A terminal apparatus configured to communicate with a server, to receive a program data comprising a video content from the server, and to record and play back the video content, the terminal apparatus comprising:
a request module configured to send a request for distribution list data comprising a list of video contents to the server;
a display controller configured to display a distribution list on a display based on distribution list data received in response to the request;
a distribution event detection module configured to detect a distribution event for viewing an available video content for viewing in the distribution list;
a distribution request transmitter configured to transmit a distribution request to the server for a video content for the detected distribution event, when the distribution event is detected;
a playback module configured to play back distributed program data from the server in response to the distribution request;
a viewing reservation event detection module configured to detect a viewing reservation event while the terminal device is playing back the preview content in the distributed program data; and
a viewing reservation command transmitter configured to transmit the viewing reservation command of the second video content to the server, when the terminal device detects the viewing reservation event.
